(19) United States
(12) Patent Application Publication
(10) Pub. No.: US 2023/0294112 A1
(43) Pub. Date: Sep. 21, 2023

(54) ROTOR WITH IMPROVED SPILL CONTROL

(71) Applicant: Fiberlite Centrifuge LLC, Santa Clara, CA (US)

(72) Inventor: Sina Piramoon, San Jose, CA (US)

(21) Appl. No.: 17/836,291

(22) Filed: Jun. 9, 2022

Related U.S. Application Data
(60) Provisional application No. 63/320,324, filed on Mar. 16, 2022.

(51) Int. Cl. B04B 7/02; B04B 5/04

(52) U.S. Cl. CPC B04B 7/02; B04B 5/0414; B04B 2007/025

(57) ABSTRACT

A rotor assembly that includes a rotor body having a plurality of rotor wells. The rotor body includes an upstanding annular lip that defines an annular containment groove configured to capture and retain material leaked from a sample container received a rotor well during rotation of the rotor assembly. The rotor body also includes an annular containment lip that forms a continuous extension of the annular containment groove. The rotor assembly includes a lid selectively attachable to the open end of the rotor body that includes a first undercut channel configured to receive a portion of a first sealing gasket formed as an annular disk. The lid is supported above the upper surface of the rotor body by the annular containment lip such that the first sealing gasket is positioned between the lid and the annular containment lip to form a seal between the lid and the rotor body.

### CROSS-REFERENCE TO RELATED APPLICATION

The present application claims the filing benefit of U.S. Provisional Application Serial No. 63/320,324, filed Mar. 16, 2022, the disclosure of which is incorporated herein by reference in its entirety.

### FIELD OF THE INVENTION

This invention relates generally to centrifuge rotors and, more particularly, to a connection between a rotor lid and a centrifuge rotor for retaining material leaked from a sample container during rotation of the centrifuge rotor.

### BACKGROUND OF THE INVENTION

Centrifuge rotors are typically used in laboratory centrifuges to hold samples during centrifugation. While centrifuge rotors may vary significantly in construction and in size, one common rotor structure is the fixed-angle rotor having a solid rotor body with a plurality of receiving chambers, or rotor wells, distributed radially within the rotor body and arranged symmetrically about an axis of rotation of the rotor. Samples in sample containers of appropriate size are placed in the plurality of rotor wells, allowing a plurality of samples to be subjected to centrifugation when the rotor is rotated.

Fixed-angle centrifuge rotors are commonly used in high rotation applications where the speed of the centrifuges may exceed hundreds or even thousands of rotations per minute. During centrifugation of samples contained within the sample containers held by the centrifuge rotor, these high centrifugal forces can result in the leakage of sample material through the sample container closures. Such leakage can be caused by ruptured sample containers or a loose or dislodged sample container cap, for example. In any event, once sample material leaks or spills from a sample container during or before centrifugation, it is important to contain the leaked sample material within the rotor to maintain a safe and clean working environment.

In view of the above, certain spillage containment improvements have been made to centrifuge rotors to prevent the ejection of leaked or spilled material from the centrifuge rotor during centrifugation. One such improvement is the use of a lid having an O-ring gasket for sealing closed the centrifuge rotor. One example of such a lid for use with a centrifuge rotor is described in U.S. Pat. No. 8,147,392 (owned by the Assignee of the present disclosure), the disclosure of which is expressly incorporated herein by reference in its entirety. Another improvement for containing leaked material within the centrifuge rotor during centrifugation is described in U.S. Pat. No. 10,272,446 (owned by the Assignee of the present disclosure), the disclosure of which is expressly incorporated herein by reference in its entirety. In that improvement, the upstanding annular lip of the centrifuge rotor is provided with an annular liquid containment groove that is spaced above the upper end of the rotor body. The annular liquid containment groove is configured to capture leaked sample material during centrifugation so that it is not ejected from the rotor during centrifugation.

However, as rotational speeds of centrifugal rotors are increased to achieve adequate material separation for high rotation applications, which can result in upwards of 40,000xg being exerted on samples contained in sample containers, further improvements to centrifuge rotors are needed to prevent the egress of leaked or spilled sample material from the centrifuge rotor at these high rotational speeds.

Therefore, a need exists for centrifuge rotors to have an improved connection between the rotor lid and the centrifuge rotor for retaining sample material that is leaked or spilled from a sample container during rotation of the centrifuge rotor at high rotational speeds.

### SUMMARY OF THE INVENTION

The present invention overcomes the foregoing and other shortcomings and drawbacks of conventional spillage containment designs of centrifuge rotors for use in centrifugation. While the present invention will be discussed in connection with certain embodiments, it will be understood that the present invention is not limited to the specific embodiments described herein.

According to one embodiment of the invention, a rotor assembly is provided that includes a rotor body having a plurality of rotor wells spaced circumferentially about a rotational axis of the rotor body. Each of rotor well includes an open end formed in an upper surface of the rotor body and is configured to receive a sample container therein. The rotor body includes an upstanding annular lip that extends in an axial direction above the upper surface of the rotor body to define an open end of the rotor body, and defines an annular containment groove configured to capture and retain material leaked from a sample container received a rotor well during rotation of the rotor assembly and an annular containment lip that extends radially inward toward the rotational axis of the rotor body to form a continuous extension of the annular containment groove. The rotor assembly includes a lid selectively attachable to the open end of the rotor body to form a cavity between the upper surface of the rotor body and an underside of the lid. The lid includes a first undercut channel that extends radially inward from a periphery of the lid and circumferentially about the lid that is configured to receive a portion of a first sealing gasket formed as an annular disk with generally planar and parallel upper and lower surfaces. The lid is supported above the upper surface of the rotor body by the annular containment lip such that the first sealing gasket is positioned between the lid and the annular containment lip to form a seal between the lid and the rotor body.

According to one aspect of the present invention, the lid of the rotor assembly includes an upper peripheral portion, a middle peripheral portion, and a lower peripheral portion. The middle peripheral portion and the lower peripheral portion are separated from each other by the first undercut channel. In a further aspect, the upper peripheral portion defines a first outer diameter of the lid, the middle peripheral portion defines a second outer diameter of the lid that is less than the first outer diameter, and the lower peripheral portion defines a third outer diameter of the lid that is less than the second outer diameter. In yet another aspect of the present invention, the lower peripheral portion of the lid is positioned laterally opposite a radially inward terminal wall of the annular containment lip to define a first interface between the lid and the rotor body. In that regard, the first sealing gasket is configured to extend across the first interface from the first undercut channel to overlie the annular containment lip.

In yet another aspect according to the present invention, the lid includes a second undercut channel that is configured to receive a portion of a second sealing gasket therein. The second undercut channel is formed between the upper peripheral portion of the lid and the middle peripheral portion of the lid. In a further aspect, the middle peripheral portion of the lid is positioned laterally opposite an inner wall of the upstanding annular lip to define a second interface between the lid and the rotor body. According to another aspect of the present invention, the inner wall of the upstanding annular lip is stepped to define an annular ledge configured to align with the second undercut channel of the lid such that the second sealing gasket extends across the second interface from the second undercut channel to overlie the annular ledge.

According to one aspect of the present invention, the annular containment lip includes a chamfered surface that extends between a radially inward terminal wall of the annular containment lip and the annular containment groove. In another aspect of the present invention, a radially inward end of the chamfered surface is flush with the underside of the lid to form a smooth transition between the underside of the lid and the annular containment groove.

According to another aspect of the present invention, the lid comprises an upper peripheral portion, a middle peripheral portion, and a lower peripheral portion with the upper peripheral portion and the middle peripheral portion being separated from each other by the second undercut channel. In a further aspect, the upper peripheral portion defines a first outer diameter of the lid, the middle peripheral portion defines a second outer diameter of the lid that is less than the first outer diameter, and the lower peripheral portion defines a third outer diameter of the lid that is less than the second outer diameter. In yet another aspect, the lower peripheral portion is positioned laterally opposite a radially inward terminal wall of the annular containment lip to define a first interface between the lid and the rotor body. In that regard, the first sealing gasket being configured to extend across the first interface from the first undercut channel to overlie the annular containment lip. In another aspect, underside of the lid is defined in part by a continuously curved surface and a chamfered surface that extends between the continuously curved surface and the lower peripheral portion of the lid that defines the third outer diameter. According to one aspect, the chamfered surface forms a continuous extension of the annular containment groove at the first interface.

According to one aspect of the present invention, the rotor body is a fixed-angle rotor body. According to another aspect of the present invention, the rotor assembly is in combination with a centrifuge.

According to another embodiment of the invention, a rotor assembly is provided that includes a rotor body having a plurality of rotor wells spaced circumferentially about a rotational axis of the rotor body. Each rotor well includes an open end formed in an upper surface of the rotor body and is configured to receive a sample container therein. The rotor body includes an upstanding annular lip that extends in an axial direction above the upper surface of the rotor body to define an open end of the rotor body. The upstanding annular lip defines an annular containment groove configured to capture and retain material leaked from a sample container received within at least one of the plurality of rotor wells during rotation of the rotor assembly, an annular containment lip that extends radially inward toward the rotational axis of the rotor body to form a continuous extension of the annular containment groove, and a top inner wall that extends between the open end of the rotor body and the annular containment lip. The rotor assembly further includes a lid selectively attachable to the open end of the rotor body to form a cavity between the upper surface of the rotor body and an underside of the lid. The lid includes a first undercut channel that extends radially inward from a periphery of the lid and circumferentially about the lid that is configured to receive a portion of a first sealing gasket therein and a second undercut channel that extends radially inward from a periphery of the lid and circumferentially about the lid that is configured to receive a portion of a second sealing gasket therein. The lid is supported above the upper surface of the rotor body by the annular containment lip such that the first sealing gasket is positioned between the lid and the annular containment lip to form a first seal between the lid and the rotor body and the second sealing gasket is positioned between the lid and the top inner wall to form a second seal between the lid and the rotor body.

According to one aspect of the present invention, the first sealing gasket is an annular disk having generally planar and parallel upper and lower surfaces.

According to another aspect of the present invention, the lid includes an upper peripheral portion, a middle peripheral portion, and a lower peripheral portion with the upper peripheral portion and the middle peripheral portion being separated from each other by the second undercut channel and the middle peripheral portion and the lower peripheral portion being separated from each other by the first undercut channel. According to another aspect, the upper peripheral portion defines a first outer diameter of the lid, the middle peripheral portion defines a second outer diameter of the lid that is less than the first outer diameter, and the lower peripheral portion defines a third outer diameter of the lid that is less than the second outer diameter. According to one aspect, the lower peripheral portion of the lid is positioned laterally opposite a radially inward terminal wall of the annular containment lip to define a first interface between the lid and the rotor bod. In that regard, the first sealing gasket is configured to extend across the first interface from the first undercut channel to overlie the annular containment lip. According to another aspect, the middle peripheral portion of the lid is positioned laterally opposite the inner wall of the upstanding annular lip to define a second interface between the lid and the rotor body.

According to yet another aspect of the present invention, the inner wall of the upstanding annular lip is stepped to define an annular ledge configured to align with the second undercut channel of the lid such that the second sealing gasket extends across the second interface from the second undercut channel to overlie the annular ledge. In one aspect, the annular containment lip includes a chamfered surface that extends between a radially inward terminal wall of the annular containment lip and the annular containment groove. In another aspect, a radially inward end of the chamfered surface is flush with the underside of the lid to form a smooth transition between the underside of the lid and the annular containment groove.

According to one aspect of the present invention, the rotor body is a fixed-angle rotor body.

According to yet another embodiment of the invention, a rotor assembly is provided that includes a rotor body having a plurality of rotor wells spaced circumferentially about a rotational axis of the rotor body. Each of the plurality of rotor wells includes an open end formed in an upper surface of the rotor body and is configured to receive a sample container therein. The rotor body includes an upstanding annular lip that extends in an axial direction above the upper surface of the rotor body to define an open end of the rotor body. The upstanding annular lip defines an annular containment groove configured to capture and retain material leaked from at least one sample container received within at least one of the plurality of rotor wells during rotation of the rotor assembly and an annular containment lip that extends radially inward toward the rotational axis of the rotor body to form a continuous extension of the annular containment groove. The rotor assembly also includes a lid selectively attachable to the open end of the rotor body to form a cavity between the upper surface of the rotor body and an underside of the lid. The lid includes a stepped profile that defines annular shoulder having an annular socket. The annular shoulder is configured to receive a first sealing gasket with an annular projection that is configured to be received within the annular socket to maintain engagement between the first sealing gasket and the annular shoulder. The lid is supported above the upper surface of the rotor body by the annular containment lip such that the first sealing gasket is positioned between the annular shoulder and the annular containment lip to form a seal between the lid and the rotor body.

According to one aspect of the invention, the lid includes an upper peripheral portion and a lower peripheral portion separated from each other by the annular shoulder. The upper peripheral portion defines a first outer diameter of the lid and the lower peripheral portion defining a second outer diameter of the lid that is less than the first outer diameter. According to another aspect, the lower peripheral portion of the lid is positioned laterally opposite a radially inward terminal wall of the annular containment lip to define a first interface between the lid and the rotor body and the upper peripheral portion of the lid is positioned laterally opposite an inner wall of the upstanding annular lip to define a second interface between the lid and the rotor body. According to yet another aspect, the lid includes an undercut channel formed in the upper peripheral portion that is configured to receive a portion of a second sealing gasket therein. According to one aspect, the upper peripheral portion defines the first outer diameter and a third outer diameter of the lid separated from each other by the first undercut channel, the third outer diameter being less than the first outer diameter but greater than the second outer diameter.

According to one aspect of the present invention, the inner wall of the upstanding annular lip defines an annular ledge configured to align with the undercut channel of the lid such that the second sealing gasket extends across the second interface from the first undercut channel to overlie the annular ledge. According to another aspect, the annular containment lip includes a chamfered surface that extends between a radially inward terminal wall of the annular containment lip and the annular containment groove. According to yet another aspect, a radially inward end of the chamfered surface is flush with the underside of the lid to form a smooth transition between the underside of the lid and the annular containment groove.

According to one aspect of the present invention, the rotor body is a fixed-angle rotor body. According to another aspect of the present invention, the rotor assembly is in combination with a centrifuge.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to explain the one or more embodiments of the invention.

FIG. 1 is a perspective view of an exemplary centrifuge rotor including a rotor body and a lid, with the lid of the centrifuge rotor removed, in accordance with an aspect of the invention.

FIG. 2 is a cross-sectional view of the rotor of FIG. 1 with the lid attached to the rotor body, illustrating a sample container installed in a rotor well for centrifugation of a sample contained in the sample container.

FIG. 3A is an enlarged detail view similar to FIG. 3B, showing the lid removed from the rotor body.

FIG. 3B is an enlarged partial view of outlined area 3A in FIG. 2.

FIG. 4 is an enlarged view similar to that of FIG. 3B, illustrating details of an engagement between a rotor lid and an upstanding annular lip of a rotor body according to another embodiment of the present invention.

FIG. 5 is a perspective view of an exemplary centrifuge rotor including a rotor body and a lid, with the lid of the centrifuge rotor removed, in accordance with another embodiment of the present invention.

FIG. 6 is a cross-sectional view of the rotor of FIG. 1, illustrating the lid attached to the rotor body.

FIG. 7A is an enlarged detail view similar to FIG. 7B, showing the lid removed from the rotor body.

FIG. 7B is an enlarged partial view of outlined area 7A in FIG. 6.

FIG. 8 is a diagrammatic view showing a centrifuge rotor installed in an exemplary centrifuge.

### DETAILED DESCRIPTION OF THE INVENTION

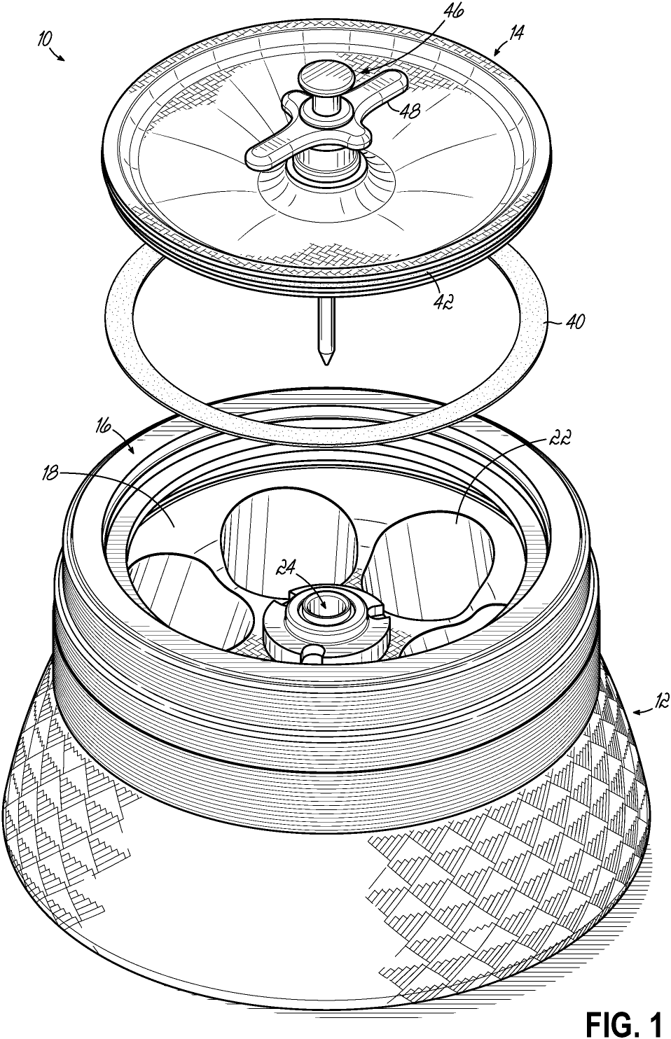

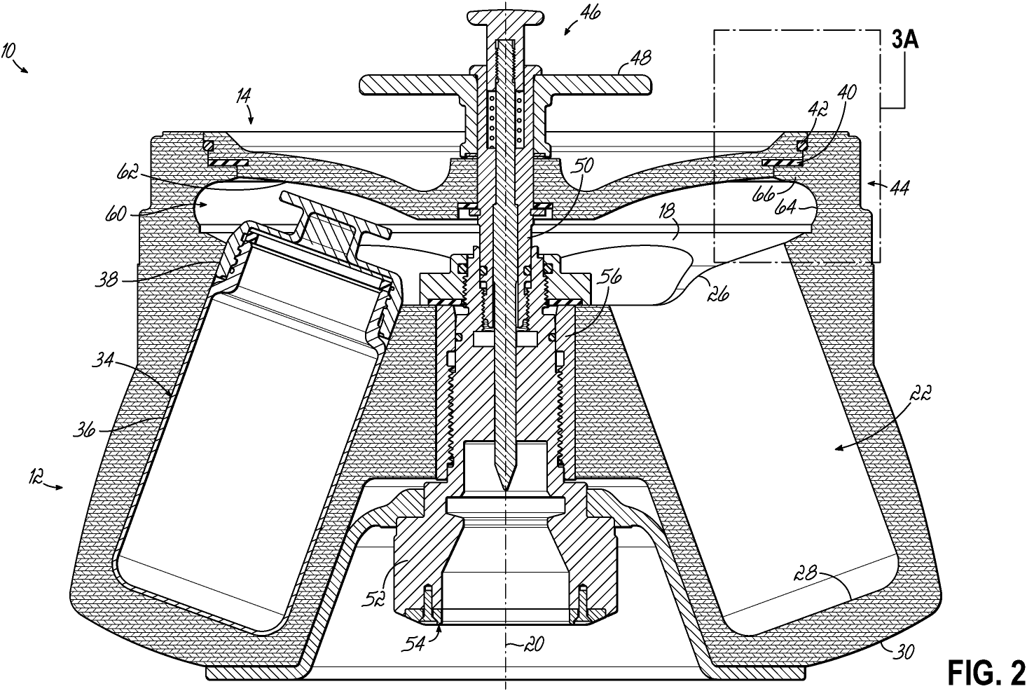

FIGS. 1-2 illustrate an exemplary centrifuge rotor 10 in accordance with one embodiment of the present invention. The rotor 10, otherwise referred to as a rotor assembly, includes a rotor body 12 and a rotor lid 14 configured to be coupled to an open end 16 of the rotor body 12 and supported above an upper surface 18 of the rotor body 12 during centrifugation of a sample, for example. The rotor body 12 is symmetrical about an axis of rotation 20 and includes a plurality of rotor wells 22 (otherwise referred to as receiving chambers or cell hole cavities) formed in the rotor body 12 and distributed radially, in a symmetrical arrangement, about a vertical bore 24 formed through the axial center of the rotor 10. To this end, the lid 14 blocks access to one or more sample containers held in the rotor wells 22 during high speed rotation of the rotor 10.

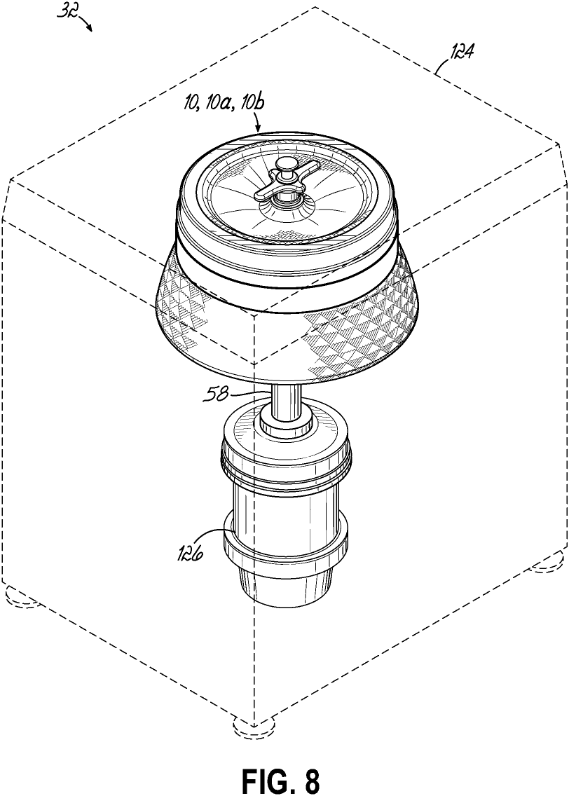

Each rotor well 22 formed in the rotor body 12 is generally cylindrical in shape and extends from an opening 26 in the upper surface 18 of the rotor body 12 to a closed rotor well base 28 near a bottom surface 30 of the rotor body 12. As used herein, the “upper surface” of the rotor body 12 refers to the generally top-most and open end 16 of the rotor body 12 along the axis of rotation 20 of the rotor 10, at which end the sample containers are loaded and unloaded. Conversely, the “bottom surface” of the rotor body 12 refers to the generally bottom-most end of the rotor body 12 along the rotational axis 20, at which end the rotor is supported by a centrifuge 32 (FIG. 8).

As shown in FIG. 2, each rotor well 22 is fixed at an angle relative to the axis of rotation 20 of the rotor 10, with the opening 26 to each rotor well 22 being located closer to the axis of rotation 20 of the rotor 10 compared to the corresponding base 28 of the rotor well 22. In that regard, the exemplary rotor 10 is a fixed-angle rotor and may be similar in many respects to the rotor fully described U.S. Pat. No. 8,323,169, which is incorporated herein by reference in its entirety, and which has six tubular-shaped rotor wells 22 for receiving sample containers therein. However, while the rotor 10 is shown and described in the context of a fixed-angle rotor having certain characteristics, it will be understood that the same inventive concepts related to embodiments of the present invention may be implemented with different types of centrifuge rotors such as swinging-bucket rotors and vertical rotors, for example, without departing from the scope of the invention. To this end, the drawings are not intended to be limiting.

The exemplary rotor 10 is a high-speed fixed-angle rotor. For these types of fixed-angle rotors, it is preferable to include a limited number of rotor wells 22, such as ten or less, for example. In the exemplary embodiment shown, the rotor body 12 includes six rotor wells 22. Each rotor well 22 is appropriately sized to receive an appropriately sized cylindrically-shaped centrifuge bottle assembly 34 therein for centrifugation of a sample stored in the bottle assembly 34. The centrifuge bottle 34 shown in FIG. 2 is merely illustrative and it is understood that other sample containers may be held in the rotor wells 22 for centrifugation of samples. In any event, the bottle assembly 34 includes a sample container 36 configured to hold a volume of a sample and a cap 38 threaded to the sample container 36 for containing the sample in the container 36. A typical centrifugal operation may include placing one bottle assembly 34 containing a volume of a sample in each rotor well 22 for centrifugation of the samples. To this end, it is not uncommon for the centrifugal forces experienced at high rotational speeds to cause sample material to leak from the bottle assembly 34 through the connection between the sample container 36 and the cap 38, for example.

With reference to FIGS. 1-2, the rotor 10 further includes a first sealing gasket 40 and a second sealing gasket 42 configured to be coupled to the generally disk-shaped lid 14 so as to be extending about a periphery of the lid 14. More particularly, when the lid 14 is coupled to the rotor body 12, the first and second sealing gaskets 40, 42 are located between the lid 14 and an upstanding annular lip 44 of the rotor body 12 to form a seal therebetween to seal closed the open end 16 of the rotor body 12 which is defined by the upstanding annular lip 44. As described in further detail below, the engagement between the lid 14 and the upstanding annular lip 44 of the rotor body 12 operates to contain sample material leaked or spilled within the centrifuge rotor 10 during centrifugation and, more particularly, during high rotational speeds of the rotor 10. In this regard, the exemplary high-speed fixed-angle rotor 10 is used in high rotation applications where the rotational speed of the rotor wells 22 and samples supported therein may exceed thousands or tens of thousands of rotations-per-minute (rpm). For example, a typical high speed centrifugal application may require that the rotor 10 spin at a rate of between 10,000 rpm to 17,000 rpm, and up to 37,000 rpm, to achieve adequate material separation.

With continued reference to FIGS. 1-2, the rotor lid 14 includes a handle assembly 46 with a handle 48 for assisting a user in attaching and removing the lid 14 relative to the rotor body 12. In particular, the handle 48 may be rotated for locking the lid 14 with, or unlocking the lid 14 from, the rotor body 12, and may be gripped for vertically moving the lid 14 into engagement with or away from the rotor body 12 after loading or unloading sample containers 34. Additionally, the handle 48 may be gripped by the user for supporting the rotor 10 in a substantially vertical direction, for example when inserting the rotor 10 into, or removing the rotor 10 from, the centrifuge 32, or when transporting the rotor 10, for example.

The handle assembly 46 further includes a lid screw 50 configured to be threadably coupled to a lid screw retainer 52 for securing the rotor lid 14 to the rotor body 12, as depicted in FIG. 2. The lid screw retainer 52 defines a hub 54 and is threadably coupled to a hub retainer 56 in an arrangement that is coaxial with the vertical bore 24 formed in the rotor body 12. In that regard, the vertical bore 24 is configured to receive a series of hardware such as the hub retainer 56, lid screw retainer 52, and lid screw 50, for example, to secure the rotor 10 to a centrifuge spindle 58 of the centrifuge 32 (FIG. 8) for high-speed centrifugal rotation of the rotor 10.

FIG. 2 depicts the rotor lid 14 coupled to the rotor body 12. In that regard, the lid screw 50 is inserted axially through the vertical bore 24 and the handle 48 used to engage the lid screw 50 with the lid screw retainer 52. Rotation of the lid screw 50, via the handle 48, may be performed by a user for threadably engaging and disengaging the lid screw 50 with the lid screw retainer 52. When the lid screw 50 is fully threadedly engaged with the lid screw retainer 52, a base portion of the handle 48 exerts an axial compressive force on the rotor lid 14, thereby securing the lid 14 to the rotor body 12. When so positioned, the rotor lid 14 blocks access to the sample containers 34 held in the rotor wells 22 and forms a cavity 60 between the upper surface 18 of the rotor body 12 and an underside 62 of the lid 14. As described in further detail below, the sealing engagement between the rotor lid 14 and the rotor body 12 operates to contain sample material leaked from the sample container(s) 34 within the cavity 60 during high speed centrifugation to thereby maintain a safe and clean working environment, for example.

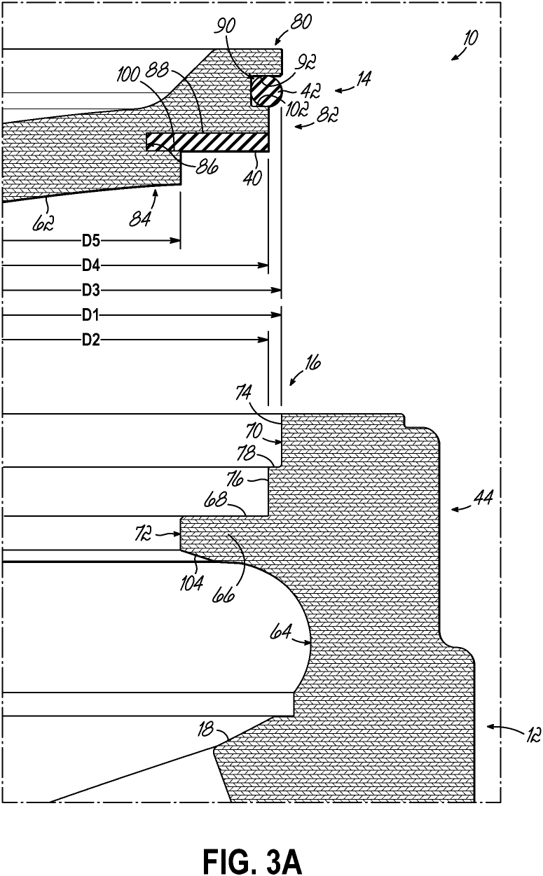

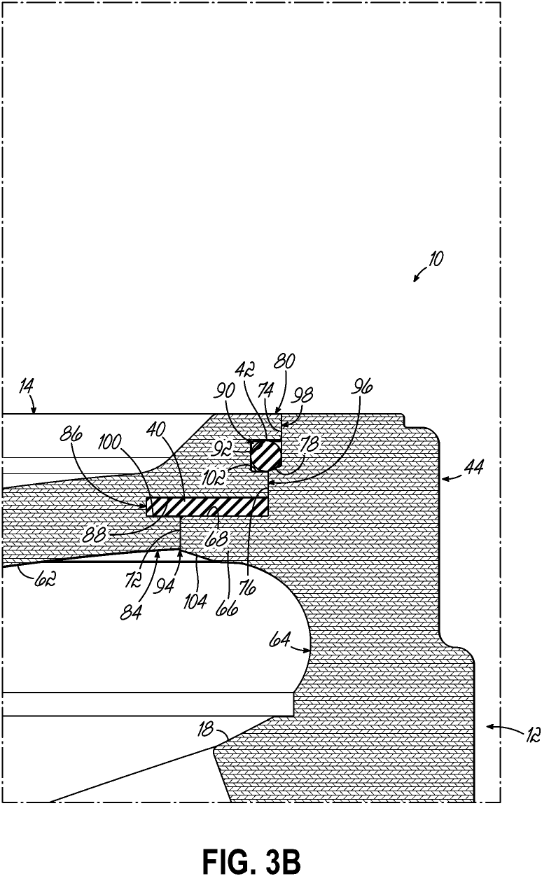

With continued reference to FIG. 2, the upstanding annular lip 44 of the rotor body 12 extends in an axial direction above the upper surface 18 of the rotor body 12 to define the open end 16 of the rotor body 12 and is configured to receive an outer circumferential portion of the rotor lid 14 to support the rotor lid 14 above the upper surface 18 of the rotor body 12. The upstanding annular lip 44 is shaped to define an annular containment groove 64 and an annular containment lip 66 that extends a distance in a radially inward direction toward the rotational axis 20 of the rotor 10. Both the annular containment lip 66 and the annular containment groove 64 extend circumferentially about the upstanding annular lip 44. As shown in FIGS. 3A-3B, the annular containment lip 66 defines an annular, horizontal ledge 68, that extends between an inner sidewall 70 of the upstanding annular lip 44 and a radially inward terminal wall 72 of the annular containment lip 66. The inner sidewall 70 of the upstanding annular lip 44 is formed with a stepped profile and extends between the horizontal ledge 68 of the annular containment lip 66 and the open end 16 of the rotor body 12. The annular containment groove 64 extends between the upper surface 18 of the rotor body 12 and the annular containment lip 66. To this end, the annular containment lip 66 forms a continuous extension of the annular containment groove 64.

The annular containment groove 64 is spaced axially above the upper surface 18 of the rotor body 12 and is concave so as to extend a distance radially outward of the upper surface 18 of the rotor body 12. In this regard, the curvature of the annular containment groove 64 operates to capture a majority of any sample material leaked from a sample container 34 into the cavity 60 to thereby prevent the egress of the leaked sample material from the rotor 10 during centrifugation. However, in certain circumstances, leaked sample material must travel along the underside 62 of the lid 14 and over an interface between the lid 14 and the rotor body 12 before it can be captured in the annular containment groove 64. For conventional high-speed fixed-angle rotors, if there is a sufficient quantity of leaked sample material traveling over the interface between the lid 14 and the rotor body 12, the centrifugal forces imposed by the rotor 10 at high rotational speeds can result in enough fluid pressure to force the leaked sample material through the interface and out of the rotor cavity 60. The improved engagement between the lid 14 and the rotor body 12 of the present invention, as described in more detail below, facilitates the movement of leaked sample material over the interface between the lid 14 and the rotor body 12 and prevents the egress of leaked sample material from the cavity 60 of the rotor 10 during rotation of the rotor 10, particularly at high rotational speeds.

As shown in FIG. 3A, the inner sidewall 70 of the upstanding annular lip 44 is formed with a stepped profile that defines a top inner sidewall 74 and a lower inner sidewall 76 separated by an annular ledge 78. In that regard, the top inner sidewall 74 defines an upper inner diameter D1 of the upstanding annular lip 44 that is greater than a lower inner diameter D2 defined by the lower inner sidewall 76. Stated another way, the top inner sidewall 74 is spaced further away, in a radial direction, from the axis of rotation 20 of the rotor 10 than the lower inner sidewall 76. The difference between the two diameters D1, D2 defines a width of the annular ledge 78 which extends between the top inner sidewall 74 and the lower inner sidewall 76. The stepped profile of the upstanding annular lip 44 corresponds to a shape of the periphery of the lid 14, as described below.

With reference to FIGS. 3A-3B, the periphery of the lid 14 is stepped to define an upper peripheral portion 80, a middle peripheral portion 82, and a lower peripheral portion 84. The lid 14 includes a first undercut channel 86 formed between the lower peripheral portion 84 and the upper/middle peripheral portions 80, 82 that is configured to receive part of the first sealing gasket 40 therein. The first undercut channel 86 extends circumferentially about the periphery of the lid 14 and defines part of a first annular shoulder 88 of the lid 14. The lid 14 also includes a second undercut channel 90 formed between the middle peripheral portion 82 and the upper peripheral portion 80 that is configured to receive part of the second sealing gasket 42 therein. The second undercut channel 90 also extends circumferentially about the periphery of the lid 14 and defines part of a second annular shoulder 92 of the lid 14. To this end, the upper peripheral portion 80 defines a first outer diameter D3, the middle peripheral portion 82 defines a second outer diameter D4 of the lid 14, and the lower peripheral portion 84 defines a third outer diameter D5 of the lid 14. The first outer diameter D3 of the lid 14 is greater than the second outer diameter D4 of the lid 14 which is greater than the third outer diameter D5 of the lid 14 (i.e., D3>D4>D5).

As shown in FIG. 3B, when the lid 14 is coupled to the rotor body 12, the lower peripheral portion 84 is positioned laterally opposite of the terminal wall 72 of the annular containment lip 66 to form a first interface 94 between the lid 14 and the rotor body 12, the middle peripheral portion 82 is positioned laterally opposite of the lower inner sidewall 76 of the upstanding annular lip 44 to form a second interface 96, and the upper peripheral portion 80 is positioned laterally opposite of the top inner sidewall 74 of the upstanding annular lip 44 to form a third interface 98 between the lid 14 and the rotor body 12. The first annular shoulder 88 of the lid 14 is configured to face the horizontal ledge 68 of the annular containment lip 66 and the second annular shoulder 92 is configured to face the annular ledge 78 of the upstanding annular lip 44 to support the lid 14 above the upper surface 18 of the rotor body 12. Ideally, the lid 14 is formed such that, when the lid 14 rests upon horizontal ledge 68 and the annular ledge 78 of the upstanding annular lip 44, there is sliding contact between the lid 14 and the upstanding annular lip 44 at each of the interfaces 94, 96, 98 therebetween that does not impede removal of the lid 14. To create a tight seal, the lid 14 is forced downwardly with the handle assembly 46 as described above. The first and second sealing gaskets 40, 42 received in respective undercut channels 86, 90, when pressed downwardly, expand in a radial direction to create seals between the lid 14 and the rotor body 12, as shown in FIG. 3B.

As shown in FIGS. 3A-3B, the first undercut channel 86 is configured to receive part of the first sealing gasket 40 therein. More particularly, the first undercut channel 86 extends a distance from the lower peripheral portion 84 of the lid 14, in a radially inward direction toward a center of the lid 14 to define a first annular brim 100 of the lid 14. The portion of the first sealing gasket 40 that is received within the first undercut channel 86 is sandwiched between the first annular brim 100 and the first annular shoulder 88 of the lid 14. To this end, the first annular brim 100 extends circumferentially about the periphery of the lid 14. The fit between the first sealing gasket 40 and the first undercut channel 86 may be a frictional fit to hold the first sealing gasket 40 to the lid 14, for example. As a result of the frictional fit, when the lid 14 is removed from the rotor body 12, as shown in FIG. 3A, the first sealing gasket 40 remains engaged with the lid 14 via the first undercut channel 86. The first sealing gasket 40 is shaped as an annular disk having generally planar and parallel upper and lower surfaces. The first sealing gasket 40 generally extends between the first undercut channel 86 and the middle peripheral portion 82 and along the first annular shoulder 88 of the lid 14.

With continued reference to FIGS. 3A-3B, the second undercut channel 90 extends between the upper peripheral portion 80 and the middle peripheral portion 82 of the lid 14 and is configured to receive part of the second sealing gasket 42 therein. More particularly, the second undercut channel 90 extends a distance from the middle peripheral portion 82 of the lid 14, in a radially inward direction toward a center of the lid 14, to define a second annular brim 102 of the lid 14. To this end, the second annular brim 102 extends circumferentially about the periphery of the lid 14. As shown, the second sealing gasket 42, which may be an O-ring, for example, is partially received within the second undercut channel 90 such that part of the second sealing gasket 42 is sandwiched between the second annular shoulder 92 and the second annular brim 102. Thus, the fit between the second sealing gasket 42 and the second undercut channel 90 may be considered to be a frictional fit, for example. As a result of the frictional fit, when the lid 14 is removed from the rotor body 12, as shown in FIG. 3A, the second sealing gasket 42 remains engaged with the lid 14 via the second undercut channel 90. As the exemplary second sealing gasket 42 is illustrated as an O-ring, the cross-sectional shape of the second sealing gasket 42 is circular. However, it is understood that the second sealing gasket 42 may have other cross-sectional shapes, such as square or other polygonal shapes, for example.

As shown in FIG. 3B, when the lid 14 is coupled to the rotor body 12, the first annular brim 100 is aligned with the horizontal ledge 68 of the annular containment lip 66 such that first sealing gasket 40 extends across the first interface 94 from the first undercut channel 86 to the lower inner sidewall 76 of the upstanding annular lip 44 to overlie the horizontal ledge 68 of the annular containment lip 66. As a result of this arrangement, when pressed downwardly by the lid 14, the first sealing gasket 40 is pressed between a portion of the first annular shoulder 88 of the lid 14 and the horizontal ledge 68 of the annular containment lip 66 to form a seal between the lid 14 and the rotor body 12 over first interface 94. Similarly, the second annular brim 102 is aligned with the annular ledge 78 of the upstanding annular lip 44 such that second sealing gasket 42 extends across the second interface 96 from the second undercut channel 90 to the top inner sidewall 74 of the upstanding annular lip 44 to overlie the annular ledge 78. As a result of this arrangement, when pressed downwardly by the lid 14, the second sealing gasket 42 is pressed between a portion of the second annular shoulder 92 of the lid 14 and the annular ledge 78 of the upstanding annular lip 44 to form a seal between the lid 14 and the rotor body 12 over second interface 96. The sealing effect provided by the combination of the first and the second sealing gaskets 40, 42, as well as the stepped, labyrinth-like engagement between the lid 14 and the rotor body 12, operate to contain leaked or spilled sample material within the cavity 60 of the rotor 10 at high rotational speeds.

As described above, in certain circumstances, leaked sample material must travel along the underside 62 of the lid 14 and over the first interface 94 before it can be captured in the annular liquid containment groove 64. At high rotational speeds, such as 16,500 rpm, for example, fluid pressure may force the leaked sample material through the interface 94 and toward the first sealing gasket 40. To prevent the leaked sample material from entering the first interface 94, the annular containment lip 66 includes a chamfered surface 104 that extends between the radially inward terminal wall 72 of the annular containment lip 66 and the annular containment groove 64. As shown in FIG. 3B, a radially inward end of the chamfered surface 104 is flush with the underside 62 of the lid 14 to form a smooth transition between the underside 62 of the lid 14 and surfaces of the annular containment groove 64. This smooth transition provides a path of least resistance for leaked sample material that may travel along the underside 62 of the lid 14 to the annular containment groove 64. Thus, rather than flow into the first interface 94, the leaked sample material will flow past the first interface 94 and into the annular containment groove 64 to be held during rotation of the rotor 10.

Testing was run on a prototype of the rotor assembly 10 described above to evaluate the performance of the spillage containment improvements. It was observed that the embodiment of the present invention described above successfully prevents the egress of a volume of leaked sample material that is up to 10% of a single 250 mL centrifuge bottle assembly from a centrifuge rotor being rotated at 16,500 rpm.

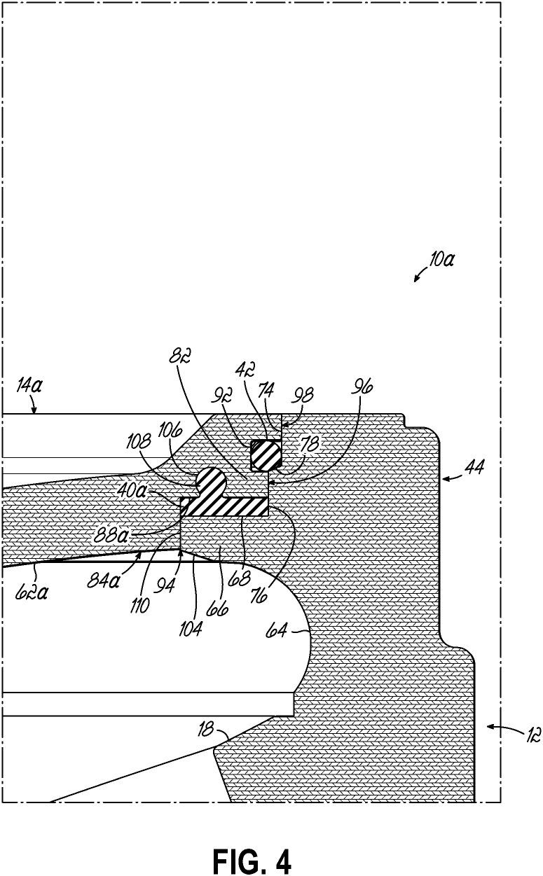

Referring now to FIG. 4, wherein like numerals represent like features, details of a portion of an exemplary rotor 10a are shown in accordance with another embodiment of the present invention. The primary differences between the rotor 10a of this embodiment and the rotor 10 of the previously described embodiment is that the first annular shoulder 88a of the lid 14a includes an annular socket 106 configured to receive an annular projection 108 of the first sealing gasket 40a to maintain engagement between the first sealing gasket 40a and the first annular shoulder 88a of the lid 14a. As a result of the interlocking engagement between the annular socket 106 and the annular projection 108 of the first sealing gasket 40a, the lid 14a does not include the first undercut channel 86 like the lid 14 of the previously described embodiment. Rather, a circumferential sidewall 110 of the lower peripheral portion 84a extends directly between the first annular shoulder 88a and the underside 62a of the lid 14a. Thus, when the lid 14a is coupled to the rotor body 12, as shown, the first sealing gasket 40a extends between the circumferential sidewall 110 of the lower peripheral portion 84a to the lower inner sidewall 76 of the upstanding annular lip 44 to overlie the horizontal ledge 68 of the annular containment lip 66. To this end, when pressed downwardly by the lid 14a, the first sealing gasket 40a is pressed between the first annular shoulder 88a of the lid 14a and the horizontal ledge 68 of the annular containment lip 66.

The annular socket 106 formed in the shoulder 88a and the annular projection 108 of the first sealing gasket 40a are each circular in cross-sectional shape. However, other cross-sectional shapes are possible, such as triangular, trapezoidal, or other suitable polygonal shapes, for example. The interlocking engagement between the annular socket 106 and the annular projection 108 may be described as a dovetail-type joint. The pliability of the gasket material used to form the first sealing gasket 40a allows the annular projection 108 to be pressed into engagement with the annular socket 106 to couple the first sealing gasket 40a to the lid 14a.

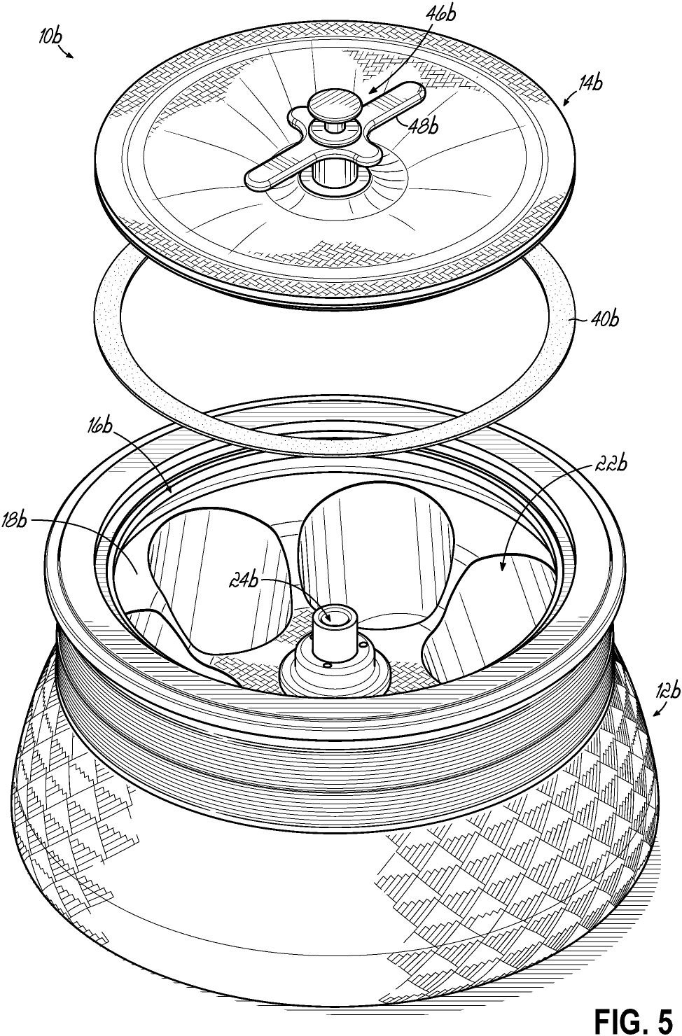

Referring now to FIG. 5-7B, wherein like numerals represent like features, details of another exemplary rotor 10b are shown in accordance with another embodiment of the present invention. While the exemplary rotor 10b of this embodiment is also a high-speed rotor, it is rated for lower rotational speeds compared to the rotors 10, 10a of the above-described embodiments. For example, the exemplary rotor 10b of this embodiment may have a maximum rotational speed of 9,000 rpm. As a result, the primary differences between the rotor 10b of this embodiment and the rotors 10, 10a of the previously described embodiments is that the lid 14b includes only one sealing gasket, being the first sealing gasket 40b. Furthermore, the structures of the lid 14b and the upstanding annular lip 44b of the rotor 10b are changed to accommodate the single-gasket seal therebetween, as described in further detail below.

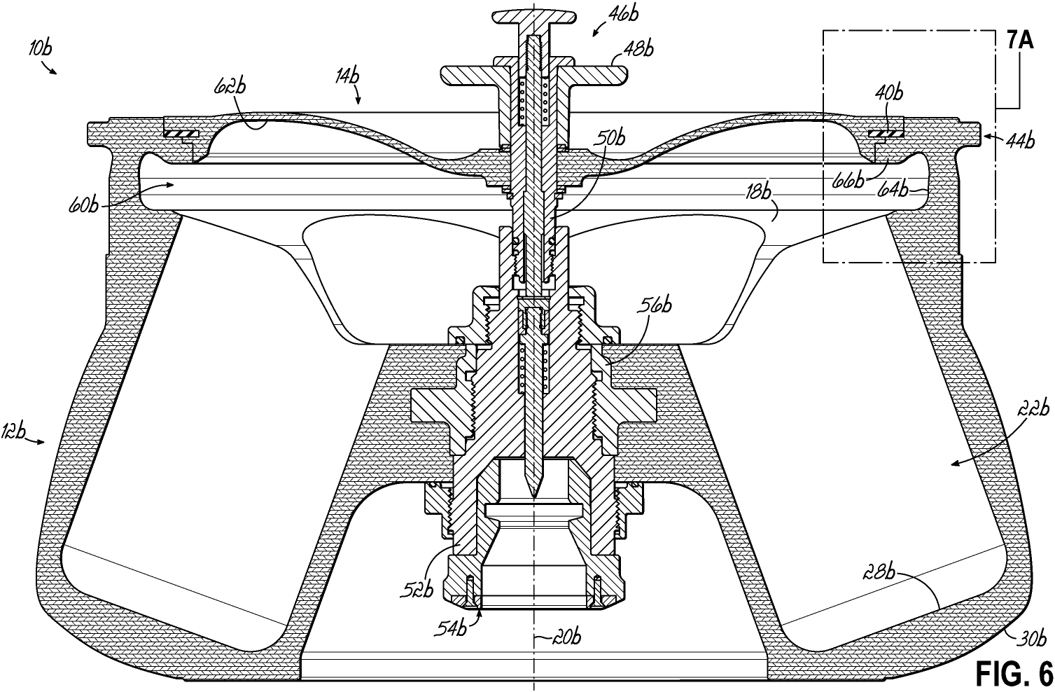

As shown in FIGS. 5-6, The rotor 10b includes a rotor body 12b and a rotor lid 14b configured to be coupled to an open end 16b of the rotor body 12b and supported above an upper surface 18b of the rotor body 12b during centrifugation of a sample. The rotor body 12b is symmetrical about an axis of rotation 20b and includes a plurality of rotor wells 22b formed in the rotor body 12b and distributed radially, in a symmetrical arrangement, about a vertical bore 24b formed through the axial center of the rotor 10b. To this end, the rotor 10b is a high-speed fixed-angle rotor with each rotor well 22b fixed at an angle relative to the axis of rotation 20b of the rotor 10b. The rotor 10b may have six rotor wells 22b each being configured to receive an appropriately sized centrifuge bottle assembly (not shown) therein for centrifugation of a sample, for example.

The rotor 10b includes the first sealing gasket 40b configured to be received about a periphery of the generally disk-shaped lid 14b. When the lid 14b is coupled to the rotor body 12b, the first sealing gasket 40b located between the lid 14b and an upstanding annular lip 44b of the rotor body 12b to form a seal therebetween to thereby seal closed the open end 16b of the rotor body 12b. The rotor lid 14b includes a handle assembly 46b with a handle 48b for assisting a user in attaching and removing the lid 14b relative to the rotor body 12b. In this regard, the handle assembly 46b includes a lid screw 50b configured to be threadably coupled to a lid screw retainer 52b for securing the rotor lid 14b to the rotor body 12b, as depicted in FIG. 6. To this end, the vertical bore 24b is configured to receive a series of hardware such as the hub retainer 56b, lid screw retainer 52b, and lid screw 50b, for example, to secure the rotor 10 to the centrifuge spindle 58 of the 32 centrifuge (FIG. 8) for high-speed centrifugal rotation of the rotor 10b.

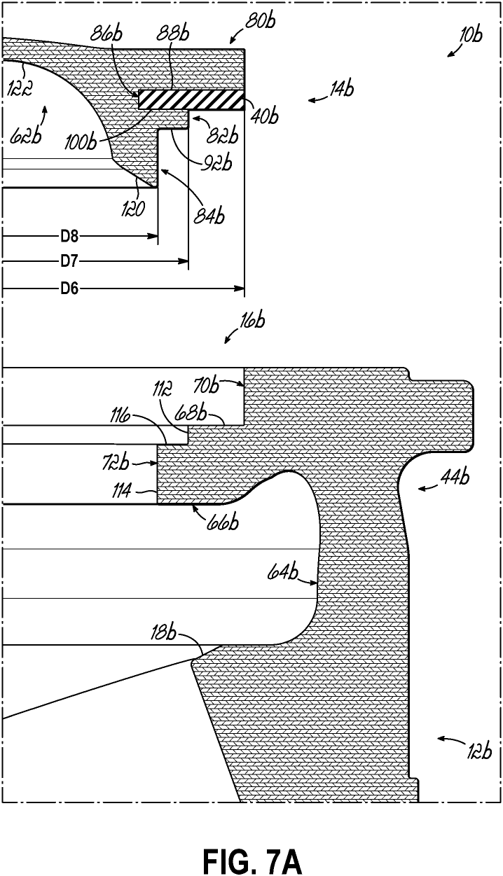

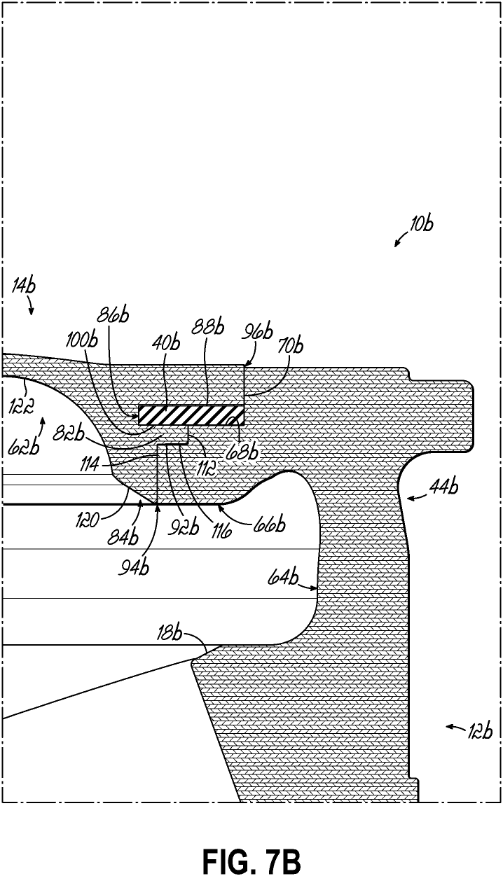

With continued reference to FIG. 6, the upstanding annular lip 44b of the rotor body 12b extends in an axial direction above the upper surface 18b of the rotor body 12b to define the open end 16b of the rotor body 12b and is configured to receive an outer circumferential portion of the rotor lid 14b to support the rotor lid 14b above the upper surface 18b of the rotor body 12b. As shown in FIGS. 7A-7B, the upstanding annular lip 44b is shaped to define an annular containment groove 64b and an annular containment lip 66b that extends a distance in a radially inward direction toward the rotational axis 20b of the rotor 10b. Both the annular containment lip 66b and the annular containment groove 64b extend circumferentially about the upstanding annular lip 44b.

The annular containment lip 66b defines a horizontal ledge 68b that extends between an inner sidewall 70b of the upstanding annular lip 44b and a radially inward terminal wall 72b of the annular containment lip 66b. As best shown in FIGS. 7A-7B, the radially inward terminal wall 72b is stepped to define a top wall section 112 and a bottom wall section 114 separated by an annular ledge 116. The inner sidewall 70b of the upstanding annular lip 44b extends between the horizontal ledge 68b of the annular containment lip 44b and the open end 16b of the rotor body 12b. The annular containment groove 64b extends between the upper surface 18b of the rotor body 12b and the annular containment lip 66b. To this end, the annular containment lip 66b forms a continuous extension of the annular containment groove 64b.

The annular containment groove 64b is spaced axially above the upper surface 18b of the rotor body 12b and is concave so as to extend a distance radially outward of the upper surface 18b of the rotor body 12b. The curvature of the annular containment groove 64b of this embodiment may be more dramatic compared to the annular containment groove 64 of the rotor 10 of the previously described embodiments. In that regard, an upper portion of the annular containment groove 64b curves inwardly on itself toward the upper surface 18b of the rotor body 12b to form a small pocket. In any event, the annular containment groove 64b operates to capture sample material leaked from a sample container into the cavity 60b to thereby prevent the egress of the leaked sample material from the rotor 10b during centrifugation.

With continued reference to FIGS. 7A-7B, the periphery of the lid 14b is stepped to define an upper peripheral portion 80b, a middle peripheral portion 82b, and a lower peripheral portion 84b. The lid 14b includes a single, first undercut channel 86b formed between the upper peripheral portion 80b and the middle peripheral portion 82b that is configured to receive part of the first sealing gasket 40b therein. The first undercut channel 86b extends circumferentially about the periphery of the lid 14b and defines part of a first annular shoulder 88b of the lid 14b. The stepped profile between the middle peripheral portion 82b and the lower peripheral portion 84b defines a second annular shoulder 92b of the lid 14b. To this end, the upper peripheral portion 80b defines a first outer diameter D6, the middle peripheral portion defines a second outer diameter D7 of the lid, and the lower peripheral portion defines a third outer diameter D8 of the lid. The first outer diameter D6 of the lid is greater than the second outer diameter D7 of the lid which is greater than the third outer diameter D8 of the lid (i.e., D6>D7>D8).

As shown in FIGS. 7A-7B, the first undercut channel 86b is configured to receive part of the first sealing gasket 40b therein. In that regard, the first undercut channel 86b extends a distance from the middle peripheral portion 82b of the lid 14b, in a radially inward direction toward a center of the lid 14b, to define a first annular brim 100b of the lid 14b. The portion of the first sealing gasket 40b that is received within the undercut channel 86b is sandwiched between the first annular brim 100b and the first annular shoulder 88b of the lid 14b. To this end, the first annular brim 100b extends circumferentially about the periphery of the lid 14b. The fit between the first sealing gasket 40b and the first undercut channel 86b may be a frictional fit to hold the first sealing gasket 40b to the lid 14b, for example. As a result of the frictional fit, when the lid 14b is removed from the rotor body 12b, as shown in FIG. 7A, the first sealing gasket 40b remains engaged with the lid 14b via the first undercut channel 86b. The first sealing gasket 40b is shaped as an annular disk having generally planar and parallel upper and lower surfaces. The first sealing gasket 40b extends from the first undercut channel 86b to the upper peripheral portion 80b and along the first annular shoulder 88b.

When the lid 14b is coupled to the rotor body 12b, as shown in FIG. 7B, the lower peripheral portion 84b is positioned laterally opposite of the bottom wall section 114 of the terminal wall 72b of the annular containment lip 66b and the middle peripheral portion 82b is positioned laterally opposite of the top wall section 112 of the terminal wall 72b of the annular containment lip 66b to form a first, step-shaped interface 94b between the lid 14b and the rotor body 12b. The upper peripheral portion 80b is positioned laterally opposite of the inner sidewall 70b of the upstanding annular lip 44b to form a second interface 96b between the lid 14b and the rotor body 12b. The first annular shoulder 88b is configured to face the horizontal ledge 68b of the annular containment lip 66b and the second annular shoulder 92b is configured to face the annular ledge 116 to support the lid 14b above the upper surface 18b of the rotor body 12b. As shown, the second annular shoulder 92b may be in direct engagement with the annular ledge 116 while the first annular shoulder 88b is indirectly engaged with the horizontal ledge 68b via the first sealing gasket 40b. When so positioned, the first annular brim 100b is aligned with the horizontal ledge 68b of the annular containment lip 44b such that first sealing gasket 40b extends across the first interface 94b from the first undercut channel 86b to the inner sidewall 70b of the upstanding annular lip 44b to overlie the horizontal ledge 68b of the annular containment lip 66b. As a result of this arrangement, when pressed downwardly by the lid 14b, a portion of the first sealing gasket 40b is pressed between a portion of the first annular shoulder 88b of the lid 14b and the horizontal ledge 68b of the annular containment lip 66b to seal closed the rotor 10b.

As a result of the flattened disc shape of the first sealing gasket 40b, the sealing gasket extends across the first interface 94b such that approximately 50% of the gasket 40b is positioned on either side of the first interface 94b. This results in a robust seal being formed over the first interface 94b to thereby prevent any leaked sample material that enters the first interface 94b from passing by the first sealing gasket 40b. Furthermore, the first interface 94b is labyrinth-like as a result of its stepped configuration, making it difficult for leaked sample material to travel up the first interface 94b to the first sealing gasket 40b. The combination of the labyrinth-like engagement between the lid 14b and the rotor body 12b at the first interface 94b and the configuration of the first sealing gasket 40b, operate to contain leaked or spilled sample material within the cavity 60b of the rotor 10b at high rotational speeds.

To prevent the leaked sample material from entering the first interface 94b at all, the underside 62b of the lid 14b includes a chamfered surface 120 that extends between a continuously curved surface 122 of the underside 62b of the lid 14b and the lower peripheral portion 84b of the lid 14b. As shown in FIG. 7B, a radially outward end of the chamfered surface 120 is flush with the annular containment groove 64b to form a smooth transition between the underside 62b of the lid 14b and surfaces of the annular containment groove 64b. This smooth transition provides a travel path of least resistance for leaked sample material that flows along the underside 62b of the lid 14b to the annular containment groove 64b. Thus, rather than flow into the first interface 94b, the leaked sample material will flow into the annular containment groove 64b to be held during rotation of the rotor 10b.

FIG. 8 depicts an exemplary centrifuge 32 according to an embodiment of the present invention. The centrifuge 32 includes a housing 124, a drive motor 126, a rotor drive shaft or spindle 58, and one of the above-described rotors 10, 10a, 10b mounted on the spindle 58. In operation, the drive motor 126 imparts rotation to the spindle 128 that, in turn, provides a rotational torque to the rotor 10, 10a, 10b to rotate the rotor 10, 10a, 10b at a desired speed.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A rotor assembly, comprising:
a rotor body having a plurality of rotor wells spaced circumferentially about a rotational axis of the rotor body, each of the plurality of rotor wells having an open end formed in an upper surface of the rotor body and being configured to receive a sample container therein, an upstanding annular lip that extends in an axial direction above the upper surface of the rotor body to define an open end of the rotor body, the upstanding annular lip defining an annular containment groove configured to capture and retain material leaked from at least one sample container received within at least one of the plurality of rotor wells during rotation of the rotor assembly, and an annular containment lip that extends radially inward toward the rotational axis of the rotor body to form a continuous extension of the annular containment groove; and
a lid selectively attachable to the open end of the rotor body to form a cavity between the upper surface of the rotor body and an underside of the lid, the lid having a first undercut channel that extends radially inward from a periphery of the lid and circumferentially about the lid that is configured to receive a portion of a first sealing gasket that comprises an annular disk having generally planar and parallel upper and lower surfaces;
wherein the lid is supported above the upper surface of the rotor body by the annular containment lip such that the first sealing gasket is positioned between the lid and the annular containment lip to form a seal between the lid and the rotor body.

2. The rotor assembly of claim 1, wherein the lid comprises an upper peripheral portion, a middle peripheral portion, and a lower peripheral portion, the middle peripheral portion and the lower peripheral portion being separated from each other by the first undercut channel.

3. The rotor assembly of claim 2, wherein the upper peripheral portion defines a first outer diameter of the lid, the middle peripheral portion defines a second outer diameter of the lid that is less than the first outer diameter, and the lower peripheral portion defines a third outer diameter of the lid that is less than the second outer diameter.

4. The rotor assembly of claim 3, wherein the lower peripheral portion of the lid is positioned laterally opposite a radially inward terminal wall of the annular containment lip to define a first interface between the lid and the rotor body, the first sealing gasket being configured to extend across the first interface from the first undercut channel to overlie the annular containment lip.

5. The rotor assembly of claim 4, wherein the lid includes a second undercut channel that is configured to receive a portion of a second sealing gasket therein, the second undercut channel being formed between the upper peripheral portion of the lid and the middle peripheral portion of the lid.

6. The rotor assembly of claim 5, wherein the middle peripheral portion of the lid is positioned laterally opposite an inner wall of the upstanding annular lip to define a second interface between the lid and the rotor body.

7. The rotor assembly of claim 6, wherein the inner wall of the upstanding annular lip is stepped to define an annular ledge configured to align with the second undercut channel of the lid such that the second sealing gasket extends across the second interface from the second undercut channel to overlie the annular ledge.

8. The rotor assembly of claim 1, wherein the annular containment lip includes a chamfered surface that extends between a radially inward terminal wall of the annular containment lip and the annular containment groove.

9. The rotor assembly of claim 8, wherein a radially inward end of the chamfered surface is flush with the underside of the lid to form a smooth transition between the underside of the lid and the annular containment groove.

10. The rotor assembly of claim 1, wherein the rotor body is a fixed-angle rotor body.

11. The rotor assembly of claim 1, wherein the lid comprises an upper peripheral portion, a middle peripheral portion, and a lower peripheral portion, the upper peripheral portion and the middle peripheral portion being separated from each other by the second undercut channel.

12. The rotor assembly of claim 11, wherein the upper peripheral portion defines a first outer diameter of the lid, the middle peripheral portion defines a second outer diameter of the lid that is less than the first outer diameter, and the lower peripheral portion defines a third outer diameter of the lid that is less than the second outer diameter.

13. The rotor assembly of claim 12, wherein the lower peripheral portion is positioned laterally opposite a radially inward terminal wall of the annular containment lip to define a first interface between the lid and the rotor body, the first sealing gasket being configured to extend across the first interface from the first undercut channel to overlie the annular containment lip.

14. The rotor assembly of claim 13, wherein the underside of the lid is defined in part by a continuously curved surface and a chamfered surface that extends between the continuously curved surface and the lower peripheral portion of the lid that defines the third outer diameter.

15. The rotor assembly of claim 14, wherein the chamfered surface forms a continuous extension of the annular containment groove at the first interface.

16. In combination, a centrifuge and the rotor assembly of claim 1.

17. A rotor assembly, comprising:
a rotor body having a plurality of rotor wells spaced circumferentially about a rotational axis of the rotor body, each of the plurality of rotor wells having an open end formed in an upper surface of the rotor body and being configured to receive a sample container therein, an upstanding annular lip that extends in an axial direction above the upper surface of the rotor body to define an open end of the rotor body, the upstanding annular lip defining an annular containment groove configured to capture and retain material leaked from at least one sample container received within at least one of the plurality of rotor wells during rotation of the rotor assembly, and an annular containment lip that extends radially inward toward the rotational axis of the rotor body to form a continuous extension of the annular containment groove and an inner wall that extends between the open end of the rotor body and the annular containment lip; and
a lid selectively attachable to the open end of the rotor body to form a cavity between the upper surface of the rotor body and an underside of the lid, the lid comprising:
a first undercut channel that extends radially inward from a periphery of the lid and circumferentially about the lid that is configured to receive a portion of a first sealing gasket therein; and
a second undercut channel that extends radially inward from a periphery of the lid and circumferentially about the lid that is configured to receive a portion of a second sealing gasket therein.
wherein the lid is supported above the upper surface of the rotor body by the annular containment lip such that the first sealing gasket is positioned between the lid and the annular containment lip to form a first seal between the lid and the rotor body and the second sealing gasket is positioned between the lid and the inner wall to form a second seal between the lid and the rotor body.

18. The rotor assembly of claim 17, wherein the first sealing gasket comprises an annular disk having generally planar and parallel upper and lower surfaces.

19. The rotor assembly of claim 17, wherein the lid comprises an upper peripheral portion, a middle peripheral portion, and a lower peripheral portion, the upper peripheral portion and the middle peripheral portion being separated from each other by the second undercut channel and the middle peripheral portion and the lower peripheral portion being separated from each other by the first undercut channel.

20. The rotor assembly of claim 19, wherein the upper peripheral portion defines a first outer diameter of the lid, the middle peripheral portion defines a second outer diameter of the lid that is less than the first outer diameter, and the lower peripheral portion defines a third outer diameter of the lid that is less than the second outer diameter.

21. The rotor assembly of claim 20, wherein the lower peripheral portion of the lid is positioned laterally opposite a radially inward terminal wall of the annular containment lip to define a first interface between the lid and the rotor body, the first sealing gasket being configured to extend across the first interface from the first undercut channel to overlie the annular containment lip.

22. The rotor assembly of claim 21, wherein the middle peripheral portion of the lid is positioned laterally opposite the inner wall of the upstanding annular lip to define a second interface between the lid and the rotor body.

23. The rotor assembly of claim 22, wherein the inner wall of the upstanding annular lip is stepped to define an annular ledge configured to align with the second undercut channel of the lid such that the second sealing gasket extends across the second interface from the second undercut channel to overlie the annular ledge.

24. The rotor assembly of claim 17, wherein the annular containment lip includes a chamfered surface that extends between a radially inward terminal wall of the annular containment lip and the annular containment groove.

25. The rotor assembly of claim 24, wherein a radially inward end of the chamfered surface is flush with the underside of the lid to form a smooth transition between the underside of the lid and the annular containment groove.

26. The rotor assembly of claim 17, wherein the rotor body is a fixed-angle rotor body.

27. A rotor assembly, comprising:
a rotor body having a plurality of rotor wells spaced circumferentially about a rotational axis of the rotor body, each of the plurality of rotor wells having an open end formed in an upper surface of the rotor body and being configured to receive a sample container therein, an upstanding annular lip that extends in an axial direction above the upper surface of the rotor body to define an open end of the rotor body, the upstanding annular lip defining an annular containment groove configured to capture and retain material leaked from at least one sample container received within at least one of the plurality of rotor wells during rotation of the rotor assembly, and an annular containment lip that extends radially inward toward the rotational axis of the rotor body to form a continuous extension of the annular containment groove; and
a lid selectively attachable to the open end of the rotor body to form a cavity between the upper surface of the rotor body and an underside of the lid, the lid having a stepped profile that defines annular shoulder having an annular socket, the annular shoulder being configured to receive a first sealing gasket having an annular projection configured to be received within the annular socket to maintain engagement between the first sealing gasket and the annular shoulder;
wherein the lid is supported above the upper surface of the rotor body by the annular containment lip such that the first sealing gasket is positioned between the annular shoulder and the annular containment lip to form a seal between the lid and the rotor body.

28. The rotor assembly of claim 27, wherein the lid includes an upper peripheral portion and a lower peripheral portion separated from each other by the annular shoulder, the upper peripheral portion defining a first outer diameter of the lid and the lower peripheral portion defining a second outer diameter of the lid that is less than the first outer diameter.

29. The rotor assembly of claim 28, wherein the lower peripheral portion of the lid is positioned laterally opposite a radially inward terminal wall of the annular containment lip to define a first interface between the lid and the rotor body and the upper peripheral portion of the lid is positioned laterally opposite an inner wall of the upstanding annular lip to define a second interface between the lid and the rotor body.

30. The rotor assembly of claim 29, wherein the lid includes an undercut channel formed in the upper peripheral portion that is configured to receive a portion of a second sealing gasket therein.

31. The rotor assembly of claim 30, wherein the upper peripheral portion defines the first outer diameter and a third outer diameter of the lid separated from each other by the first undercut channel, the third outer diameter being less than the first outer diameter but greater than the second outer diameter.

32. The rotor assembly of claim 31, wherein the inner wall of the upstanding annular lip defines an annular ledge configured to align with the undercut channel of the lid such that the second sealing gasket extends across the second interface from the first undercut channel to overlie the annular ledge.

33. The rotor assembly of claim 27, wherein the annular containment lip includes a chamfered surface that extends between a radially inward terminal wall of the annular containment lip and the annular containment groove.

34. The rotor assembly of claim 33, wherein a radially inward end of the chamfered surface is flush with the underside of the lid to form a smooth transition between the underside of the lid and the annular containment groove.

35. The rotor assembly of claim 27, wherein the rotor body is a fixed-angle rotor body.

36. In combination, a centrifuge and the rotor assembly of claim 27.
